(19) United States
(12) Patent Application Publication
(10) Pub. No.: US 2007/0219825 A1
(43) Pub. Date: Sep. 20, 2007

(54) METHOD OF MANAGING AND REDUCING SIDE EFFECTS ASSOCIATED WITH EXPOSURE TO A DRUG

(76) Inventors: Derek J. Maetzold, Friendswood, TX (US); Terrance C. Coyne, Houston, TX (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/562,457

(22) Filed: Nov. 22, 2006

Related U.S. Application Data
(60) Provisional application No. 60/738,975, filed on Nov. 23, 2005.

(51) Int. Cl. G06Q 10/00; G06F 7/00

(52) U.S. Cl. 705/2; 707/102

(57) ABSTRACT

A method for restricted distribution of a drug to a patient while minimizing the occurrence of adverse side effects. The method restricts access to the drug by preventing distribution to certain patients for whom the drug may be contraindicated. The method permits a prescription to be filled by a pharmacy only after the pharmacy has received an approval for release of the prescription. Generation of the prescription approval depends on registration of a prescriber, pharmacy and patient in a central database, and the determination that the risk is acceptable that the patient will experience an adverse side effect. The database contains a patient profile that may include additional patient-specific health-related information that is probative of the risk that an adverse side effect is likely to occur if the patient is exposed to the drug. Based in part on the information in the patient profile, the registered prescriber makes a determination as to the patient's risk of adverse side effects. If the registered prescriber determines that the risk is acceptable, a prescription request is generated. At the time that the prescription is to be dispensed to the patient, the pharmacy also makes a determination as to the patient's risk of adverse side effects. If the pharmacy determines that the risk is acceptable, the drug is dispensed to the patient. Additional steps may be taken to ensure compliance with the drug delivery method, such as education, oversight by a drug safety analyst, and/or regular contact with a representative.

The present application claims priority to U.S. Provisional Application No. 60/738,975, filed Nov. 23, 2005, the contents of which are incorporated herein by reference in their entirety.

### BACKGROUND OF THE INVENTION

1. Field of the Invention

Embodiments relate to methods for delivering a drug to a patient. More particularly, the methods restrict access to the drug to only those patients for which the risk that they will experience an adverse side effect is acceptable. This restricted drug distribution method enables healthcare providers to manage and reduce side effects associated with exposure to a contraindicated condition.

2. Description of Related Art

Many beneficial drugs are known or suspected of producing adverse side effects in certain individuals. These side effects may be manifest in the patient taking the drug, in a fetus carried by the patient, or in a recipient (or fetus carried by a recipient) of the bodily fluids of the patient. In some cases, administration of the drug may be acceptable in some patients, but absolutely contraindicated in other patients. For example, drugs known or suspected of causing birth defects if taken by a pregnant woman (i.e. teratogenic drugs), may nonetheless be beneficial for treating certain conditions. However, because of the teratogenic properties of the drug, administration to pregnant women must be avoided. In other instances, a drug may be beneficially employed in the general population, but must be avoided by individuals having a certain preexisting condition, or those concurrently taking certain other medication(s), due to adverse side effects which may develop in those individuals.

U.S. Pat. No. 6,045,501, to Elsayed et al., provides methods for delivering a drug to a patient while preventing the exposure of a fetus or other contraindicated individual to the drug. According to the methods of this patent, prescriptions for the drug are filled only after a computer readable storage medium has been consulted to assure that the prescriber is registered in the medium and qualified to prescribe the drug, that the pharmacy is registered in the medium and qualified to fill the prescription for the drug, and the patient is registered in the medium and approved to receive the drug.

U.S. Pat. No. 6,315,720 to Williams, et al., provides methods for delivering a drug to a patient in need of the drug, while avoiding the occurrence of an adverse side effect known or suspected of being caused by the drug. According to the methods of the patent, patients are assigned to risk groups based upon the risk that taking the drug will lead to the side effect, and certain additional information, such as periodic surveys and diagnostic tests probative of the ongoing risk of the side effect developing are obtained before prescriptions for the drug are approved.

The description herein of certain advantages and disadvantages of known methods is not intended to limit the scope of the embodiments. Indeed, the embodiments may include some or all of the above-described methods without suffering from the same disadvantages.

### SUMMARY OF THE INVENTION

In view of the foregoing, it would therefore be desirable to provide a method for restricted delivery of a drug that provides a combination of some or all of the following elements: (i) a method for registering prescribers, patients, and pharmacies with a program to enable restricted distribution of the drug; (ii) a method for providing education and counseling to prescribers, patients, pharmacies, laboratories, and clinics who may need to interact with the patient during their drug treatment program, specifically related to the drug and the drug delivery method; (iii) a method for collecting and providing up-to-date patient-specific health information beyond what is collected in an office examination to enable a physician or others responsible for overseeing the drug treatment program to better manage the drug treatment program and minimize undesired side effects; (iv) a method for providing a secondary review of the patient's health to help identify any risk factors in a patient to help prevent the occurrence of adverse side effects; and (v) a drug service center to manage and ensure compliance with the above elements.

Therefore, in accordance with the features of the embodiments, there is provided a method for restricting distribution of a drug to a patient while minimizing the occurrence of adverse side effects by preventing access to the drug to certain patients for whom the drug may be contraindicated. The method of the embodiments comprises permitting a prescription order to be filled by a pharmacy only after the pharmacy has received an approval for release for the prescription.

In accordance with the features of one embodiment, the generation of the prescription approval comprises providing a database, in which at least one prescriber, at least one pharmacy and the patient are registered; creating a patient profile in the database, and associating the patient profile with the patient, the at least one registered prescriber, and the at least one registered pharmacy; defining a baseline set of information to be obtained from the patient, wherein said baseline set of information is probative of the risk that an adverse side effect is likely to occur if the patient is exposed to the drug; obtaining a patient-specific baseline set of information, and associating the patient-specific baseline set of information with the patient profile; enabling the at least one registered prescriber to access to the patient profile in the database; based at least in part on the baseline set of information in the patient profile, allowing the at least one registered prescriber to determine whether the risk is acceptable that the patient will experience an adverse side effect upon exposure to the drug; and upon a determination by the registered prescriber that the risk is acceptable, generating a prescription approval;

wherein after the prescription approval has been generated, the at least one registered pharmacy is permitted to dispense the drug to the patient as ordered by the prescription.

In accordance with features of another embodiment, generation of the prescription approval comprises providing a database; registering at least one prescriber in the database; registering at least one pharmacy in the database; registering the patient in the database; creating a patient profile in the database, and associating the patient profile with the patient, the at least one registered prescriber, and the at least one registered pharmacy; enabling the at least one registered prescriber to access to patient's profile in the database; providing one or more drug safety analysts; enabling the one or more drug safety analysts to access the patient's profile in the database; defining a baseline set of information to be obtained from the patient, wherein said baseline set of information is probative of the risk that an adverse side effect is likely to occur if the patient is exposed to the drug; obtaining a patient-specific baseline set of information from the patient and associating the patient-specific baseline set of information with the patient profile; based at least in part on the baseline set of information in the patient profile, allowing the one or more drug safety analysts to determine whether the risk is acceptable that the patient will experience an adverse side effect upon exposure to the drug; upon a determination by the one or more drug safety analysts that the risk is not acceptable, notifying the at least one registered prescriber that said determination has been made; based at least in part on the patient-specific baseline set of information in the patient profile, allowing the at least one registered prescriber to determine whether the risk is acceptable that the patient will experience an adverse side effect upon exposure to the drug; and upon a determination by the at least one registered prescriber that the risk is acceptable, generating a prescription approval; wherein after the prescription approval has been generated, the at least one registered pharmacy is permitted to dispense the drug to the patient as ordered by the prescription.

Another exemplary embodiment provides a method for restricting distribution of a drug to a patient while minimizing the occurrence of adverse side effects, where the method comprises providing a database, in which one or more patients are registered; associating each of the one or more registered patients with respective patient profiles in the database; defining a baseline set of information to be obtained from each of the one or more patients, wherein said baseline set of information is probative of the risk that an adverse side effect is likely to occur if the patient is exposed to the drug; obtaining a patient-specific baseline set of information from each of the one or more patients, and associating each of the patient-specific baseline sets of information with the respective patient profiles; after obtaining patient-specific baseline sets of information from each of the one or more patients, dispensing the drug to each of the one or more patients; defining a second set of information to be obtained from each of the one or more patients after the drug has been dispensed, wherein said second set of information is probative of the risk that an adverse side effect is likely to occur if the patient continues to be exposed to the drug; obtaining at least one second set of patient-specific information from each of the one or more patients at a predetermined interval after the drug has been dispensed to the one or more patients, and associating each of the second sets of patient-specific information with the respective patient profiles; and evaluating the baseline and second sets of patient-specific information in the collective patient profiles to determine the effectiveness of the drug.

These and other features of various embodiments will be readily apparent from a review of the detailed description of preferred embodiments taken in conjunction with the attached drawings.

### BRIEF DESCRIPTION OF THE DRAWINGS

FIG. 1 is a flow chart illustrating a method for registering a patient with the drug service center, according to an exemplary program described herein;

FIG. 2 is a flow chart illustrating a method for determining and verifying a patient's pregnancy status, according to an exemplary program described herein; and

FIG. 3 is a flow chart illustrating a method for a specialty pharmacy to follow prior to dispensing a drug, according to an exemplary program described herein; and

FIG. 4 is a flow chart illustrating a method for a specialty pharmacy to follow to contact the patient on a monthly basis, according to an exemplary program described herein; and

FIG. 5 is a flow chart illustrating a feature of an embodiment of a method for restricting distribution of a drug, according to an alterative embodiment described herein.

### DETAILED DESCRIPTION OF PREFERRED EMBODIMENTS

Embodiments disclosed herein are directed generally to methods for delivering a drug known or suspected of causing an adverse side effect to patients, and continuously monitoring the patients for adverse side effects. The term “drug,” as used herein, refers to any substance which is intended for use in the diagnosis, cure, mitigation, treatment or prevention of disease, or to affect the structure or function of the body. The phrase “side effect,” as used herein, refers to any abnormality, defect, mutation, lesion, degeneration or injury that may be caused by taking the drug. The side effect may be one that is likely to arise in the patient, or in a fetus carried by the patient. The side effect may also be one which is likely to arise in a recipient of the bodily fluid of the patient, or the fetus carried by such recipient. As used herein, the phrase “likely to arise” means that the side effect known or suspected of being caused by the drug may be expected to occur at a higher incidence rate in a particular individual or group of individuals.

Generally speaking, the embodiments may be desirably and advantageously used to educate and reinforce the actions and behaviors of patients who are taking a drug, as well as prescribers who prescribe the drug, and pharmacies that dispense the drug. As used herein, the term “prescriber” refers to any individual capable of prescribing drugs, including, for example, a medical doctor. Such education and reinforcement of actions and behaviors are often necessary to ensure proper prescribing and dispensing of the drug, as well as patient compliance with taking the drug. A wide variety of educational materials may be employed to ensure proper prescribing, dispensing and patient compliance according to the methods described herein, including, for example, a variety of literature and other materials, such as, for example, product information, educational brochures, continuing education monographs, videotapes, and the like which may describe the risks and benefits associated with taking the particular drug and the measures which may be taken to avoid these risks.

The methods described herein may be advantageously employed to avoid distribution of one or more drugs known or suspected of causing an adverse side effect to a patient for whom the drugs may be contraindicated. The term “contraindicated,” as used herein, refers to any condition in a patient which renders a particular line of treatment, including the administration of one or more drugs, undesirable or improper. This condition may be preexisting, or may develop while the patient is taking the drugs, including conditions which may result directly or indirectly from treatment with the drugs. Thus, contraindicated drugs include, for example, teratogenic drugs whose administration to pregnant patients is importantly avoided due to risks to the fetus. A drug may also be considered contraindicated if use of the drug by patients who are also taking another drug is known or suspected of producing an adverse side effect in those patients, or in a fetus carried by such patients.

The methods of the embodiments are especially advantageously employed for the purpose of restricted distribution of a teratogenic drug. Drugs that are capable of acting as teratogens include, for example, the following drugs: antihypertensive ACE (angiotensin converting enzyme) inhibitors such as benazepril (LOTENSIN), captopril (CAPOTEN), enalapril (VASOTEC), fosinopril sodium (MONOPRIL), lisinopril (ZESTRIL, PRINIVIL), lisinopril+hydorcholorthiazide (ZESTORETIC, PRINZIDE), quinapril (ACCUPRIL) and ramipril (ALTACE); acne medication isotretinoin (ACCUTANE, RETIN-A); androgens (male hormones); antibiotics tetracycline (ACHROMYCIN), and doxycycline (VIBRAMYCIN), and streptomycin; anticoagulant (blood-thinner) warfarin (COUMADIN); anticonvulsants (seizure medications) such as phenytoin (DILANTIN), valproic acid (DEPAKENE, VALPROTATE), trimethadione (TRIDIONE), paramethadione (PARADIONE), and carbamazepine (TEGRETOL); antidepressant drug lithium (ESKALITH, LITHOB); antimetabolite/anticancer drugs such as methotrexate (RHEUMATREX) and aminopterin; antirheumatic agent and metal-binder (chelator) penicillamine (CIPRIMENE, DEPEN); antithyroid drugs such as thiouracil/propylthiouracil and carbimazole/methaimazole; DES (diethylstilbestrol), a hormone; thalidomide (THALOMID) which was approved by the FDA for the treatment of a complication of leprosy; and drugs used to treat people diagnosed with pulmonary arterial hypertension, such as ETRA's (endothelin receptor antagonists) bosentan (TRACLEER) and sitaxsentan sodium, and combinations of ETRA's with compounds such as phosphodiesterase 5 (PDE5) inhibitors.

The restricted distribution of a teratogenic drug to a patient may be advantageously achieved with the present methods while substantially (including completely) avoiding the delivery of the drug to a fetus. The term “substantially,” as used in reference to avoiding the delivery of a teratogenic drug to a fetus, generally means that there is an avoidance rate of delivering the drug to a fetus of greater than about 50%. Preferably, the avoidance rate is greater than about 55%, with an avoidance rate of greater than about 60% being more preferred. Even more preferably, the avoidance rate is greater than about 65%, with an avoidance rate of greater than about 70% being still more preferred. Yet more preferably, the avoidance rate is greater than about 75%, with an avoidance rate of greater than about 80% being still more preferred. In even more preferred embodiments, the avoidance rate is greater than about 85%, with an avoidance rate of greater than about 90% being yet more preferred. Still more preferably, the avoidance rate is greater than about 95%. In particularly preferred embodiments, a teratogenic drug may be delivered to patients with completely no delivery to fetuses (i.e., 100% avoidance rate).

The restricted drug distribution methods of the embodiments involve registration of the persons or entities involved with the distribution of the drug, with the drug manufacturer or distributor. Registration of the prescriber, patient, pharmacy, etc. according to the methods described herein, provides a means for controlling access to the contraindicated drug. For example, if a prescriber is not a registered prescriber, the prescriber will be ineligible to prescribe the drug. If a pharmacy is not a registered pharmacy, the pharmacy will be ineligible to dispense the drug. If a patient is not registered, the patient will be unable to obtain access to the drug. As such, the registration may serve to deny access to, dispensing of, or prescriptions for the contraindicated drug to patients, pharmacies, or prescribers who fail to abide by the methods of the embodiments.

The restricted drug distribution methods of the embodiments preferably involve registering a prescriber with the manufacturer or distributor of the drug. Preferably, the prescriber's registration is recorded in a database, such as one recorded on a computer readable storage medium. Once registered, the prescriber may become eligible to prescribe the drug to patients in need of the drug. Generally speaking, a registered prescriber may be required to comply with various aspects of the methods described herein such as, for example, providing patient education and counseling, ensuring that the patient complies with certain aspects of the restricted drug distribution methods, and the like, as described in detail herein. The registration of the prescriber may be achieved, for example, by providing the prescriber, by mail, facsimile transmission, or on-line transmission, with a registration card or form, preferably together with appropriate educational materials concerning the particular drug for which the prescriber is being registered to prescribe, as well as suitable methods for delivering the drug to the patient, including the drug distribution methods described herein. The prescriber preferably will complete the registration card or form by providing information requested therein, and the registration card or form will preferably be returned to the manufacturer or distributor of the drug, or other authorized recipient of the registration materials, for example, by mail, facsimile transmission or on-line transmission. Information which may be requested of the prescriber in the registration card or form may include, for example, prescriber-specific information such as the prescriber's name, address, demographic information, state licensing information, DEA#, any affiliation with one or more health care institutions, practice specialty, emergency contact information, primary office contact information, and/or office designate information. The prescriber's information in the registration card or form is then entered into the database. Suitable databases that may be employed for registration of the prescribers (as well as the pharmacies, patients, and other parties, as discussed below) will be apparent to one of ordinary skill in the art, once armed with the teachings of the present application. Preferably, the manufacturer or distributor of the drug will provide appropriate education and training to each registered prescriber with respect to the risks and benefits of the drug, prescribing details, and the method for restricting distribution, to ensure proper prescribing, dispensing, and patient compliance according to the methods described herein.

In accordance with the methods described herein, pharmacies who are qualified to fill prescriptions for the particular drug being prescribed are also preferably registered with the manufacturer or distributor of the drug. Preferably, each pharmacy's registration is recorded in a database. Preferably, the pharmacies' registrations are recorded in the same database in which the prescribers' registrations are recorded, but alternatively may be recorded in a different database. Once registered, the pharmacies may be eligible to dispense the involved drug to patients who are in need of the drug. Generally speaking, a registered pharmacy may be required to comply with various aspects of the methods described herein including, for example by ensuring that the patient complies with certain aspects of the restricted drug distribution methods, as well as other aspects of the present methods, as described in detail below. As with the registration of the prescriber, the registration of the pharmacy may be achieved by providing the pharmacy, for example, by mail, facsimile transmission, or on-line transmission, with a registration card or form, preferably together with appropriate educational materials concerning, for example, the particular drug for which the pharmacy is being registered to dispense, as well as suitable methods for delivering the drug to the patient, including the restricted distribution methods described herein. The pharmacy may then have the registration card or form completed by providing the information requested therein, which thereafter may be returned to the manufacturer or distributor of the drug, or other authorized recipient of the registration card or form, for example, by mail, facsimile transmission or on-line transmission. Information which may be requested of the pharmacy in the registration card or form may include, for example, the pharmacy's name, address, and affiliation, if any, with any health care institution such as, for example, a hospital, health care organization, and the like. The pharmacy's information in the registration card or form is then preferably entered into the database. Preferably, the manufacturer or distributor of the drug will provide appropriate education and training to each registered pharmacy with respect to the risks and benefits of the drug, prescribing details, and the method of restricted distribution of the drug, to ensure proper prescribing, dispensing, and patient compliance according to the methods described herein.

Optionally, one or more additional persons or entities associated with the drug treatment program may be registered with the manufacturer or distributor of the drug, using a method similar to those described above. For example, laboratories, hospitals, clinics, or the like, that may come in contact with a patient, or may be involved in a patient's drug treatment program may be registered. These additional persons or entities preferably will be provided with appropriate education and training with respect to the risks and benefits of the drug, prescribing details, and the method of restricted distribution of the drug, to ensure proper prescribing, dispensing, and patient compliance according to the methods described herein.

As noted above, the restricted drug distribution methods described herein also involve the registration of the patient with the manufacturer or distributor of the drug. Preferably, each patient's registration is recorded in a database. Preferably, the database in which the patients' registrations are recorded is the same database in which the prescribers' and/or pharmacies's registrations are recorded. Generally speaking, in order to become registered, the patient may be required to comply with various aspects of the methods described herein. The registration of the patient may be carried out by the prescriber, for example at the time the initial prescription is registration card or form for the patient, which includes information on the patient, such as the patient's name, sex, mailing address, date of birth, and the like. Information on the prescriber and dispensing pharmacy, such as the information described above for the registration thereof, may also be desirably entered on the patient's registration card or form. The completed form may then be forwarded to the manufacturer or distributor of the drug, or other authorized recipient of the registration form, for example, by mail, facsimile transmission, or on-line transmission. Preferably, at the time of registration, a file containing patient-specific information will created and maintained in the database. In some preferred embodiments, this registration card or form may also serve as a request for a prescription for the drug. Once it has been determined that the patient is eligible to receive the drug, the request for prescription will be released to a registered pharmacy so that a the pharmacy may dispense the prescribed drug to the patient.

Certain embodiments preferably involve requiring the patient to fill out and sign an informed consent form prior to registration. The informed consent form preferably is signed by the prescriber, as well as the patient. Preferably, this verification is provided by the prescriber, and may be included, for example, with the drug service request form. Verification that the patient has given his/her informed consent may be registered in the database. It is believed that obtaining an informed consent form of both the prescriber and the patient leads to better compliance, and hence decreases risk that an adverse side effect will occur. By filling out and signing an informed consent form, the patient acknowledges that he/she understands the risks associated with taking the drug, and agrees to comply with various aspects of the methods of delivering the drug. In the informed consent form, the patient preferably agrees to comply with the risk avoidance measures provided, and to behave in a manner which is consistent with the prescriber's counsel. For example, in cases involving teratogenic drugs, the patient may agree to use at least one form of birth control, with female patients agreeing to use at least two forms of birth control. Female patients preferably will also acknowledge that, at the time they are being prescribed the teratogenic drug, they are not pregnant, they will immediately stop taking the drug if they become pregnant, and they will not try to become pregnant for a period of time after treatment with the drug is terminated.

In preferred embodiments, at the time of registration, the patient agrees to undergo periodic diagnostic testing to screen for certain pre-determined health-related characteristics relevant to the risk that an adverse side effect to be avoided may occur or be occurring. For example, in embodiments involving teratogenic drugs, female patients preferably agree to undergo pregnancy testing, before, during and after treatment with the teratogenic drug. In embodiments involving drugs having risk of impairment to liver function, patients preferably agree to undergo blood testing to confirm proper liver function before during and after treatment with the drug.

As mentioned above, registration of the prescriber, patient, pharmacy, etc. according to the methods described herein, provides a means for controlling access to the contraindicated drug. Any person or entity that is not registered with the drug manufacturer or distributor, according to the methods described above, will be prohibited from participating in the distribution of the drug to patients.

Education and counseling is another important aspect of the method of the present embodiments. The restricted drug distribution methods of the embodiments preferably involve, inter alia, an education program to educate potential prescribers, pharmacies, laboratories, clinics, and other groups or individuals who may have interactions with patients who will be treated with the drug. Preferably, the drug manufacturer or distributor should provide appropriate education and training with respect to the risks and benefits of the drug, contraindications of the drug, and known side effects associated with the drug, prescribing details, the restricted distribution method, etc., to help ensure compliance with the methods for restricted distribution of the drug, and to help to prevent the occurrence of or treat adverse side effects in patients who are being treated with the drug. For example, a prescriber should be educated on the risks and benefits of the drug, proper prescribing, method of dispensing of the drug, and appropriate patient education. A pharmacy should be provided with information, for example, on the risks and benefits of the drug, contraindications such as drug interactions, and method of dispensing the drug. In addition, the drug manufacturer or distributor should provide education and training to laboratories, clinics, hospitals, treatment centers, and the like, that are likely have interaction with patients taking the drug, to increase their awareness of the side effects and drug interactions associated with patients treated with the drug. For example, if a drug has a known interaction with an anticoagulant therapy, the drug manufacturer or distributor should take steps to educate all known anticoagulation clinics to raise their awareness of the effect that the drug may have on any concomitant anticoagulation therapy. Education may be provided by supplying literature on the drug for which a prescription is contemplated, such as product information, package insert, medication guide, educational brochures, continuing education monographs, and the like, and/or may be accomplished with other direct training, such as with direct contact with the drug manufacturer or distributor, or other designated individuals or groups who are capable of providing training for the manufacturer or distributor.

Patient education and counseling also is an important element of the restricted drug distribution method of the embodiments described herein. When, in the course of an examination of a patient, the prescriber determines that the patient's condition may be improved by the administration of a drug, the prescriber preferably counsels the patient, for example, on the various risks and benefits associated with the drug. For example, the prescriber preferably discusses the benefits associated with taking the drug, while also advising the patient on the various side effects associated therewith. A patient who may have a condition or disease for which the drug is contraindicated is preferably counseled by the prescriber on the dangers associated therewith and advised as to risk avoidance measures which may be instituted. Preferably the patient is provided full disclosure of all the known and suspected risks associated with taking the drug. For example, in the case of teratogenic drugs, the prescriber preferably counsels the patient on the dangers of exposing a fetus, either one which may be carried by the patient or one carried by a recipient of the bodily fluids of the patient, to the teratogenic drug. Such counsel may be provided verbally, as well as in written form. In preferred embodiments, the prescriber provides the patient with literature materials on the drug for which a prescription is contemplated, such as product information, educational brochures, continuing education monographs, and the like. Thus, in the case of methods involving teratogenic drugs, the prescriber preferably provides patients with literature information, for example, in the form of the aforesaid product information, educational brochures, continuing education monographs, and the like, warning the patient of the effects of the drug on fetuses. In the case of other drugs which are known or suspected of causing an adverse side effect, the patient is counseled as to the dangers of taking the drugs, and of steps which may be taken to avoid those risks. For example, if the concomitant use of the drug and another drug, for example alcohol, is to be avoided, the prescriber advises the patient of the risks of drinking alcohol while taking the drug.

With particular reference to counseling provided in connection with teratogenic drugs, the prescriber preferably counsels female patients that such drugs must never be used by pregnant women. If the patient is a female of child-bearing potential (i.e., a woman who is capable of becoming pregnant), the prescriber preferably counsels the patient that even a single dosage of certain teratogenic drugs, such as thalidomide, may cause birth defects. Accordingly, the patient is preferably counseled to avoid sexual intercourse entirely, or if sexually active, to use appropriate forms of contraception or birth control. For both male and female patients, the prescriber preferably provides counsel on the importance of using at least two forms of effective birth control methods, with one form preferably being a highly effective hormonal method, and the other form preferably being an effective barrier method. The patients are preferably counseled to use the birth control methods for a period of time prior to and during treatment with the teratogenic drug, as well as for a period of time after treatment with the drug has been terminated. In preferred embodiments, the patient is counseled to use at least two forms of birth control for at least about 4 weeks prior to initiation of treatment, during treatment, and for at least about 4 weeks after treatment has been terminated. It may be desirable for the prescriber to personally provide female patients who are capable of becoming pregnant with one or more contraceptive devices or formulations.

Male patients who are being prescribed a teratogenic drug are preferably counseled to use condoms every time they engage in sexual relations, since many teratogenic drugs may be found in semen. Male patients are also preferably counseled to contact their prescriber if they have sexual intercourse without a condom, and/or if it is believed that they may have caused a pregnancy. As with female patients, it may be desirable for the prescriber to provide male patients who are capable of impregnating female patients with a contraceptive device or formulation. Other advice relative to birth control that the prescriber may provide to the patient would be apparent to one skilled in the art, once armed with the teachings of the present application. If the prescriber who is prescribing the teratogenic drug is unaware of certain aspects of the available forms of birth control and the advantages and disadvantages associated therewith, the patient should be referred to a prescriber who is knowledgeable on such matters, prior to be being prescribed the involved drug. Generally speaking, as discussed below, counseling on teratogenecity, birth control, and the like is preferably given only to female patients who are capable of becoming pregnant, or to male patients who are capable of having sexual relations with partners who are or can become pregnant. In this manner, unnecessary counseling, for example, to women who are no longer of child-bearing age or men who are incapable of sexual relations with such women, may be avoided.

With further reference to methods involving teratogenic drugs, it is also preferred that the prescriber advise the patient to not share the drug with anyone else, and particularly that the drug should be kept out of the reach of children as well as women of child-bearing potential. In the case of female patients, particularly female patients of child-bearing potential, the prescriber should give the patient a pregnancy test, preferably a serum pregnancy test, prior to and during treatment with the teratogenic drug. To begin receiving the teratogenic drug and to continue taking the drug, female patients of child-bearing potential should continue to have negative pregnancy tests. The patient is also preferably counseled by the prescriber to discard or return to the prescriber, pharmacy, manufacturer or distributor any unused portion of the prescribed drug.

As would be apparent to one of ordinary skill in the art, once armed with the teachings of the present application, one or more aspects of the counseling described above may be applicable, in certain circumstances, for drugs other than teratogenic drugs.

The restricted drug distribution methods of the embodiments further restricts access to the drug on the basis of patient-specific risk assessment criteria. Preferably, the drug manufacturer or distributor will identify certain health-related criteria that is probative of the risk that a known or suspected side effect will occur if the drug is taken by the patient. If, according to this criteria, it is determined that the risk associated with distributing the drug to a patient is acceptable, then the patient is eligible to receive the drug. If the risk is considered to be unacceptable, additional counseling may be provided to the patient or, if necessary, treatment of the patient with the involved drug may be terminated, with alternate treatment modalities being provided.

Accordingly, in certain embodiments, prior to the initial dispensation of the drug to a patient, a set of patient-specific health-related information is collected from the patient. This information also may be obtained on a periodic basis during and after treatment with the drug. The patient-specific information then may be compared with the manufacturer's predefined set of risk parameters for the drug, so that analysis of the information will permit recognition of the risk of the occurrence of an adverse side effect. Preferably, where the patient-specific information indicates that the risk of the adverse side effect occurring outweighs the potential benefit of the drug, the patient may be denied treatment with the drug.

This health-related information may include information not previously obtained from the patient, or may simply reiterate previously asked questions, and repeat diagnostic tests which were conducted previously. The health-related information may relate to the patient's conduct, or may relate to the patient's past or ongoing medical treatment, such as other procedures or medication which the patient may have received or is still receiving. For example, the additional health-related information may be in the form of a survey or questionnaire regarding the patient's behavior and compliance with risk avoidance measures and may thus be probative of whether the risk of occurrence of an adverse side effect has increased, decreased or remained the same.

The health-related information may include the results of certain diagnostic tests which have been performed on the patient. Such diagnostic tests may be probative, for example, of the risk of exposure of a fetus to a teratogenic drug, may test for the presence of a risk factor for the adverse side effect of concern, or may be probative of the onset of that side effect. Where the use of combinations of more than one drug are known or suspected of causing an increased risk of the occurrence of a side effect, the diagnostic testing may include testing for the presence of one or more of those drugs, or evidence of the use by the patient of such other drugs. Additionally, diagnostic tests may be probative of the concentration of one or more drugs, including the prescribed drug or drugs, to assure that appropriate dosing is maintained. Such diagnostic testing may be conducted on any bodily fluid or waste product of the patient, including the blood, serum, plasma, saliva, semen or urine, as well as the feces. Diagnostic testing may also be performed on a biopsy of any tissue of the patient or may include genetic testing, which may be indicative of a genetic predisposition to a particular adverse side effect. Other forms of diagnostic testing, such as diagnostic imaging, or tests which may be probative of the proper functioning of any tissue, organ or system are also contemplated.

If, based on an analysis of the patient-specific health-related information, it is determined that the patient's risk of side effects is significant, certain additional diagnostic tests may be required, so that baseline data may be obtained, before the prescription will be approved for filling. The patient is preferably further instructed that periodic diagnostic testing may also be necessary for continued approval of a prescription. A prescription approval generally will not be generated for subsequent prescriptions or refills until such periodic tests have been performed and satisfactory results entered into the database. If a prescription approval is not received by the pharmacy, the patient is directed to complete the requisite tests, or to return to the doctor for further consultation.

For example, the diagnostic testing may include an assay of the patient's serum liver enzyme levels, to screen for early signs of liver damage. Additionally, the diagnostic testing may include screens for the presence of other drugs known to also cause liver damage, or to be hazardous if taken in combination with the drug. If, the test results or survey indicate that the risk of liver damage has increased, the patient will be directed to consult with the prescriber before any further drug may be dispensed. In this way, the development of the adverse side effect of concern may be monitored. For example, if the tests indicate that some liver enzymes are marginally elevated, the patient may be required to undergo additional diagnostic testing before approval will be given to receive the drug. Such testing may include, for example, liver function tests, to further diagnose the level of cellular damage potentially being caused by the drug, or the combination of drug and other drugs, such as alcohol. In more extreme cases, a diagnostic ultrasound of the liver, or even a liver biopsy may even be indicated. Ultimately, if the risk of continued administration becomes so great that it outweighs the possible benefits of continued treatment with drug, the drug may no longer be dispensed to that patient.

This patient-specific health-related information is preferably recorded in a database. Once recorded in the database, the prescriber, manufacturer and/or distributor of the drug, drug safety group, as well as any group or body that may be established to generally provide oversight on the distribution of the drug may gain access to this information, and analyze it to determine therefrom the level of risk associated with the administration of the involved drug to the various patients. If the risk is considered to be acceptable, the patient may continue to receive the drug, using the methods described herein. If the risk is considered to be unacceptable, one or more of the overseeing parties may alert the others to the increased risk, enabling the pharmacy to halt further distribution of the drug (if necessary) and the prescriber to adjust the treatment modality or provide additional counseling to the patient.

According to the various embodiments, after the appropriate prescriber, pharmacy, and patient are registered and educated, and it is determined from the patient-specific health-related information collected that the risk of distributing the drug to the patient is acceptable, a prescription may be dispensed to the patient. In a preferred embodiment, the original prescription is initiated by completion and submission by the prescriber of the registration card or form, or a drug service request form. Once registration is complete, the prescription approval is not released to the registered pharmacy until it is confirmed that the patient is eligible to receive the drug. Prior to dispensing the drug, the pharmacy preferably confirms, for example, via a standard on-line transmission that the patient has been registered and is eligible to receive the drug. The pharmacy also may contact the patient to confirm that the patient is eligible to receive the drug. When patient eligibility has been confirmed, the registered pharmacy may dispense the drug to the patient. If the patient is ineligible, the pharmacy generally may not dispense the drug to the patient. The pharmacy may then contact, for example, the prescribing prescriber or the manufacturer of the drug to initiate patient registration.

The pharmacy generally provides a limited quantity of the drug to the patient (e.g., 28 days). The drug is preferably supplied to the registered pharmacy (as well as the patient) in packaging that includes warnings regarding the risks associated with the drug, as well as the importance of various aspects of the present methods such as, for example, pregnancy testing and the use of contraception (in the case of teratogenic drugs), and the dangers associated with sharing the drug with others, among other aspects.

After the initial prescription for the drug has been dispensed to the patient by the registered pharmacy, refills for the drug preferably will not be permitted without a renewal prescription. For the patient to obtain a renewal prescription, it is necessary for the patient to meet the requirements for the initial prescription, i.e., the patient, prescriber, pharmacy must still be registered, and the patient's file in the database must contain up-to-date information, including the results of a periodic survey or diagnostic tests, that indicate that the patient does not exhibit an unacceptable risk that an adverse side effect is likely to occur. Thus, preferably, the patient must visit the laboratory to have diagnostic tests completed prior to being able to obtain a refill prescription. A refill prescription is not released by the registered pharmacy until the pharmacy confirms that the patient is eligible to receive the drug. For example, the pharmacy preferably provides counseling regarding the risks and benefits associated with taking the drug, and confirms that the patient has been registered and is eligible to receive the drug, and determines what additional medications the patient is using. If the prescribed drug is a teratogenic drug, the pharmacy may confirm with the patient that he/she is using appropriate birth control, and that the patient is not pregnant. When patient eligibility has been confirmed, the pharmacy may dispense the drug to the patient. If the patient is ineligible, the pharmacy generally may not dispense the drug to the patient. The pharmacy may then contact, for example, the prescribing prescriber or the manufacturer of the drug to initiate patient registration.

Efficient communication of risk, safety, and precautionary information is beneficial to successful management of a risk avoidance plan. Therefore, in accordance with the various embodiments described herein, a centralized database is a beneficial tool for collecting, screening and disseminating information related to the restricted drug distribution program, including information regarding registered prescribers, pharmacies, and patients. Preferably, the database is maintained by the manufacturer or distributor, or an entity specially-designated to maintain the database. Preferably, the prescriber, the specialty pharmacy, and the data service center all have the ability to input data to or view data for a patient. Preferably, the database is maintained using a method that enables easy access by all accessing parties, but restricts access to other parties. For example, the database may be maintained on a secure web portal having restricted access.

When used appropriately, the database provides a useful tool for monitoring and authorizing distribution of the drug. For example, if a prescriber is not identified as a registered prescriber in the database, the prescriber will be ineligible to prescribe the drug. If a pharmacy is not identified as a registered pharmacy in the database, the pharmacy will be ineligible to dispense the drug. And if a patient is not identified as a registered patient in the database, or does not provide an informed consent form, the patient will be unable to obtain access to the drug. As such, the database may serve to deny access to, dispensing of, or prescriptions for the contraindicated drug to patients, pharmacies, or prescribers who fail to abide by the methods of the embodiments.

In addition, the database may also contain additional patient-specific health-related information that is probative of the risk that a known or suspected side effect will occur if the drug is taken by the patient. When maintained in a centralized database, this patient-specific information may be maintained and accessed by the prescriber, the pharmacy, and/or other individuals or groups who may generally provide oversight on the distribution of the drug, such as a drug safety group employed by the drug manufacturer or distributor. Preferably, the database is accessible by the prescribers so that they can review patient-specific health-related information and track the progress of their patients during therapy, to identify risk factors or occurrences of adverse side effects so that they may modify the drug treatment program accordingly. In embodiments where the patient's health-related information, such as diagnostic tests, are entered into the patient's file in the database on a periodic basis, a physician can monitor their patients' progress on a real-time basis, supplementing information gathered in office consultations and examinations. By providing access to up-to-date diagnostic test results, the physician may more promptly detect and respond to risk factors, and hence decrease the risk that adverse effects will occur. It is also believed that by providing continuous access to the patient's file in the database, a physician can better manage his or her case load, so that the methods of the embodiments provided herein may operate more efficiently.

For instance, preferably the database also is accessible by the registered pharmacies, so that they can determine if they are authorized to fill prescription for the drug. In addition, the pharmacies may enter additional health-related information that they learn from the patient, that may be important to the drug treatment program. Preferably, the database is accessible by other individuals or groups that are involved in the patient's drug treatment program, and method of restricting distribution and risk avoidance. Preferably, the database is accessible by the manufacturer or distributor of the drug, so that it may review the progress of all of the patients to determine the effectiveness of its drug. By providing access to the patient information in the database, the method allows the manufacturer or distributor to, for example, monitor trends and study the various effects of the drug treatment programs. The manufacturer or distributor of the drug, therefore, may be able to understand, for example, on a macro level how the drug and drug treatment regimens are working.

Preferably, the manufacturer or distributor of the drug employs a drug service center to help administer the method and maintain the database. The drug service center may beneficially provide a point of contact to prescribers, patients, pharmacies, and other parties associated with a patient's treatment with the drug. The drug service center preferably is staffed with experience professionals who have been trained to respond to general product inquiries, or questions regarding the methods for restricting distribution of the drug, and risk avoidance that the drug manufacturer or distributor uses. The drug service center should be able to provide other areas of support, including registering prescribers, patients, and pharmacies, answering questions related to insurance coverage, Medicaid/Medicare coverage, or financial assistance, and forwarding questions to medical professionals.

Preferably, the manufacturer or distributor of the drug employs a drug safety group that has access to the database, and is generally responsible for providing oversight on the distribution of the drug, and reviewing the information in each patient's file to ensure compliance with the program. The drug safety group preferably is staffed by one or more analysts who are medical professionals trained to analyze the information in a patient's file in the database, and recognize risk factors associated with the drug treatment regimens. The drug safety group may be authorized to intervene, as necessary, at any point in the treatment program, for example, so as to alert the prescriber to any abnormalities that may develop during the course of therapy, or to alert a registered pharmacy not to fill a prescription.

In preferred embodiments, the drug manufacturer or distributor will provide an additional outreach program to follow-up with the patient throughout their drug treatment program. For example, the patient may receive reminders, for example, via mail, facsimile, or on-line transmission, from the manufacturer, the pharmacy, the drug service center, the drug safety group, or another group or body providing oversight on drug distribution, that the patient needs to take action or submit additional information so that a refill prescription may be issued. For example, the patient may be reminded to visit a laboratory to have diagnostic testing completed, or may receive a survey to be completed and submitted for entry into the database. Such reminders preferably are delivered to the patient, for example, from about 14 to about 21 days after the previous prescription was filled.

In other preferred embodiments, representatives from the pharmacy, the drug service center or drug safety department may provide a more proactive outreach program. For example, in addition to reminding the patient to have additional diagnostic tests performed, one or more representatives may reach out to the patient to probe for information relevant to the patient's treatment, and provide additional educational counseling, as appropriate, regarding the drug and/or method of restricted distribution and risk avoidance. In certain embodiments, the representative may record this information in the patient's profile in the database, so that it is available for review by the prescriber and the drug safety analyst. The representative may become actively involved in other aspects of the restricted distribution method, such as by contacting the prescriber or pharmacy, to elicit or to share information.

The method of the various embodiments provides several potential benefits over other risk management programs, providing a more rigorous and less intrusive method for managing and reducing side effects of the drug therapy. For example, this method provides a system for physicians to access and track the results of their patient's health-related information. A centralized system is provided for physicians to receive this information, which provides a single point-of-contact. In addition, the method enables real-time monitoring of a patient's health-related information. Because data is regularly updated, and a data service center is provided and staffed to perform regular monitoring of lab test results, a physician can be promptly notified if high-risk conditions develop. Yet another benefit of the method is that it enables all parties involved in the drug treatment program to track patients involvement. For example, the system enables physicians to track prescriptions, view scheduled lab tests, contact drug specialty pharmacies, and access lab results for their patients. Furthermore, it is believed that the use of a centralized process for the collection, reporting, and ongoing analysis of lab data further enhances this type of restricted access program by alleviating certain administrative burdens that form access barriers to this type of program.

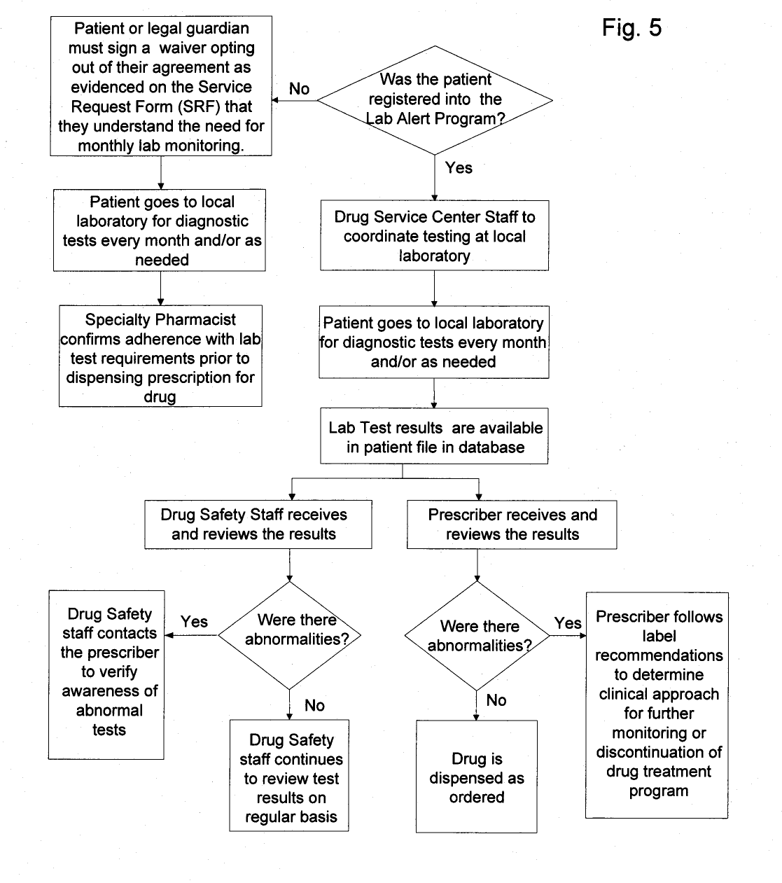

In various embodiments, the method may include a means for managing laboratory testing, to further ensure a patient's compliance with the method. For example, a patient may elect to opt-in to program (such as the Lab Alert Program illustrated in FIG. 5) including a network of preferred laboratory providers, selected by the drug manufacturer or distributor, to provide diagnostic testing on a periodic basis throughout the drug treatment program. It is In these embodiments, laboratories that are qualified to perform diagnostic tests related to the method of delivering the particular drug being prescribed are registered with the manufacturer or distributor of the drug. Once registered, a laboratory may be eligible to provide the patients who are undergoing drug treatment, with diagnostic testing services. A registered laboratory may be registered using one of the methods described above. Generally speaking, a registered laboratory may be required to comply with various aspects of the methods described herein including, for example by ensuring that the patient complies with certain aspects of the drug delivery methods, ensuring that diagnostic test data is provided to the prescriber or manufacturer or distributor in a timely fashion, as well as other aspects of the present methods, as described in detail below. Preferably, the manufacturer or distributor of the drug will provide appropriate education and training to each registered laboratory with respect to the diagnostic test methodology and data reporting requirements, to ensure proper prescribing, dispensing, and patient compliance according to the methods described herein.

In these embodiments, the patient preferably works with a registered laboratory to provide on-going lab testing as part of a regular monitoring program. In a preferred embodiment, the drug service center will coordinate testing at a preferred laboratory that is local to the patient, or that the patient selects. The patient then goes to the selected laboratory for diagnostic tests at least once a month, or more frequently as needed. The results of the diagnostic tests are entered into the patient's profile in the database, by either the laboratory or the drug service center. Once in the patient's profile, the test results are available for review by the prescriber, or pharmacist, or drug safety department, so that these parties may identify any abnormalities. If the prescriber determines that there are abnormalities in the patient's test results, the prescriber may respond with additional laboratory monitoring, or counseling. The prescriber also may adjust the treatment plan, such as following drug label recommendations to determine clinical approach for further monitoring, or discontinuing the drug treatment program. Preferably, a drug safety analyst reviews laboratory testing results on a regular basis so that he/she may identify any abnormalities in the patient's test results. If a drug safety analyst determines that there are abnormalities in the results (i.e., ALT or AST>3 X ULN, or a positive pregnancy test), the analyst may contact the prescriber to verify that the prescriber is aware of the abnormal test results, and can respond accordingly. If the prescriber determines that the patient's lab results do not exhibit any abnormalities, then the drug may be dispensed to the patient as ordered. Immediate availability of the test results to both the prescriber and the drug safety analyst ensures real-time monitoring of the lab test results, to help prevent the occurrence of adverse side effects.

In various embodiments, the drug manufacturer or distributor subsidizes the cost of the diagnostic testing provided by the preferred laboratories. It is believed that subsidizing the cost of the diagnostic tests eliminates a barrier of entry to the drug treatment method for the patient. This, in turn, leads to better compliance with the method of delivering the drug, hence decreasing the risk that an adverse side effect will occur.

In accordance with the various embodiments, therefore, the method of restricted distribution of the drug will be described in more detail in reference to an exemplary drug therapy program involving treatment with the drug sitaxsentan sodium. It will be understood, however, that the various embodiments described herein encompass, without limitation, drug therapy programs involving all classes and types of drugs, including those not described herein.

### EXAMPLE

As described herein, an exemplary restricted drug distribution program for the distribution of sitaxsentan sodium has been developed, in accordance with the restricted distribution methods provided above, to minimize the risk of side effects associated with exposure to sitaxsentan sodium. Sitaxsentan sodium is an endothelin receptor antagonist (ETRA) used to treat people diagnosed with pulmonary arterial hypertension (PAH). Clinical studies of sitaxsentan sodium have demonstrated safety and efficacy in the treatment of subjects with PAH. However, along with the many benefits, there are many risks associated with exposure to sitaxsentan sodium. For instance, ETRA's, as a class, have been associated with liver function abnormalities. In placebo-controlled trials, sitaxsentan sodium has had a documented hepatoxicity, causing at least a three-fold increase of liver aminotransferases in about two percent of patients. In addition, ETRA's, as a class, have consistently produced teratogenic effects in animals. Results from reproductive toxicology studies performed with sitaxsentan sodium indicate that dosing during pregnancy in the rat results in several fetal malformations. Although the effects of sitaxsentan sodium on human development are not known, it is likely to produce major birth defects if used by pregnant women. Sitaxsentan sodium also is contraindicated for those taking cyclosporine A (used for treatment of psoriasis and rheumatoid arthritis, and to prevent rejection of organ transplants). Finally, sitaxsentan sodium is known to antagonize the metabolism of warfarin (used to prevent blood clotting).

The exemplary restricted drug distribution program for the distribution of sitaxsentan sodium (the “program”), is an effective tool to ensure that the benefits of sitaxsentan sodium outweigh the risks for the patients treated with for patients treated with the drug. In particular, the purpose of the program is to minimize the risk of clinically significant hepatitis in patients exposed to sitaxsentan sodium; to minimize fetal exposures to sitaxsentan sodium; and to educate prescribers, patients, pharmacies, an anticoagulation clinics on the need to reduce warfarin dose when taking sitaxsentan sodium. The program assures that no patient will have access to sitaxsentan sodium unless he or she is registered, and does not exhibit significant risk factors associated with adverse side effects.

Initially, in order to receive sitaxsentan sodium, physicians and patients must register or enroll in the program, and agree to comply with the requirements of the program. In addition, drug distribution is limited to a select number of pharmacies, designated as “specialty pharmacies,” who are specially trained and experienced with specialty products. A drug service center administers the program, and ensures compliance of the parties. The drug service center provides a point of contact to prescribers, patients, pharmacies, and other parties associated with a patient's treatment with sitaxsentan sodium. The drug service center employs trained medical professionals (e.g., nurse clinicians) who are able to educate and counsel the parties, respond to questions regarding the program or the drug, register prescribers into the program, forward calls to a medical department, and provide other areas of support for the prescribers and patients. In addition, the drug service center places outbound phone calls to registered patients at regularly scheduled intervals (e.g., two weeks prior to their scheduled prescription refill) to review with the registered patient important safety information for the drug, validate continuing laboratory testing scheduling by the patient, and conduct an assessment to resolve identified barriers to patients fulfilling laboratory testing requirements. The drug service center also employs reimbursement advocates who can answer questions about insurance coverage or financial hardship programs.

The drug service center is accessible by phone, fax, and internet. The drug service center maintains a web portal to provide registered prescribers and specialty pharmacies with access to information regarding the drug treatment program. The web portal provides access to registered users (who have been issued a username and a password) to the database in which registration information is recorded, and patient-specific health-related information is maintained. The web portal may also be used to provide patient education materials, and to answer questions about insurance coverage, reimbursement, and patient support programs.

The sintaxsentan sodium program involves interventions at various phases of a patient's exposure to sitaxsentan sodium, to ensure that the drug is not dispensed to a patient that does not meet the criteria of the program. These phases can be broken down into three distinct areas: (1) pretreatment, (2) initial treatment, and (3) maintenance phase. Generally, in the pretreatment phase, a patient, a prescriber (physician), and a specialty pharmacy are registered in the centralized database, and are educated on the risks and benefits associated with the drug therapy. A patient is identified as a candidate for therapy with the sitaxsentan sodium, and is tested to confirm that he or she does not exhibit risk factors associated with adverse side effects, after which an initial prescription for sitaxsentan sodium is released to the specialty pharmacy to dispense. In the initial treatment phase, the patient is monitored on a regular basis to confirm that he or she does not exhibit risk factors associated with adverse side effects. If risk factors develop, the prescriber is alerted so that he can respond appropriately with adjustment to the drug therapy, additional monitoring, or discontinuation of the drug therapy. In the maintenance phase of therapy, continued regular monitoring occurs. Each of these phases is described in more detail below.

The pretreatment phase of the program is that period of time that occurs prior to a patient actually starting therapy. In the pretreatment phase, provider selection and education is conducted. For instance, a targeted prescriber and ancillary healthcare staff are registered, educated and trained prior to prescribing sitaxsentan sodium. Specialty pharmacies who will fill prescriptions for sitaxsentan sodium are identified, educated and trained. In this context, education and training may include provision of the package insert and medication guide, training on the risks and benefits of sitaxsentan sodium, training on prescribing details, training on reporting procedures for adverse events, training on known drug-drug interactions, training on the need for adjustment of daily warfarin dosing upon initiation of the drug treatment, and other training direct contact with personnel of the drug service center. Because of the known interaction of sitaxsentan sodium with warfarin, anticoagulation clinics also are notified of the risk for a warfarin interaction with concomitant use of sitaxsentan sodium, and are educated and trained on sitaxsentan sodium as necessary.

At registration, a representative from the drug service center contacts the prescriber to review prescribing details, provide an overview of the methods and tools used to reduce adverse side effects, and conduct in-office training and patient education. The prescriber will be provided with information such as a patient enrollment form (to register the patient), a drug medication guide, a drug service center brochure, a patient education brochure, a dosing card, and a healthcare provider fact sheet.

At the end of successful registration, the prescriber is permitted to prescribe sitaxsentan sodium treatment to a patient with PAH, and will be entered in the drug service center database as a registered prescriber. Registration in the database enables the drug service center to identify registered prescribers, and to efficiently communicate to them any significant new safety information or precautions related to sitaxsentan sodium. In addition to being permitted to prescribe the drug, a registered prescriber is provided with access to the web portal, which enables them to access patient profiles for the patients they are treating. For instance, the registered prescriber is provided with a means for access to the web portal, such as a user name and password.

Once a prescriber is registered, and determines that the patient's condition would be improved by the administration of sitaxsentan sodium, the prescriber will take steps to educate the patient, and to register him or her as a patient with the drug service center. Prior to prescribing the drug, the prescriber counsels the patient, for example, on the various risks and benefits associated with the sitaxsentan sodium. For example, the prescriber preferably discusses the benefits associated with taking the drug, while also advising the patient on the various side effects described above. The patient is provided full disclosure of all the known and suspected risks associated with taking the drug. For example, because sitaxsentan sodium is a class of teratogenic drugs, the prescriber counsels the patient on the dangers of exposing a fetus, either one which may be carried by the patient or one carried by a recipient of the bodily fluids of the patient, to the teratogenic drug. In addition, the prescriber counsels the patient on the risks of liver damage, and interference with anticoagulation therapy, and of the steps that may be taken to avoid those risks. Such counsel may be provided verbally, as well as in written form. In preferred embodiments, the prescriber provides the patient with literature materials such as product information, package insert, patient medication guide, educational brochures, continuing education monographs, and the like, warning the patient of the side effects of sitaxsentan sodium.

Prior to initiating therapy, the prescriber provides the patient with a drug service request form to complete. The purpose of the service request form is to obtain patient-specific information, to acknowledge that the patient has been educated on the risks and benefits of sitaxsentan sodium, and to obtain consent of the patient and/or legal guardian to treatment and to laboratory testing required as part of method of managing and reducing side effects associated with the treatment. The service request form also serves as a request for a prescription for the patient.

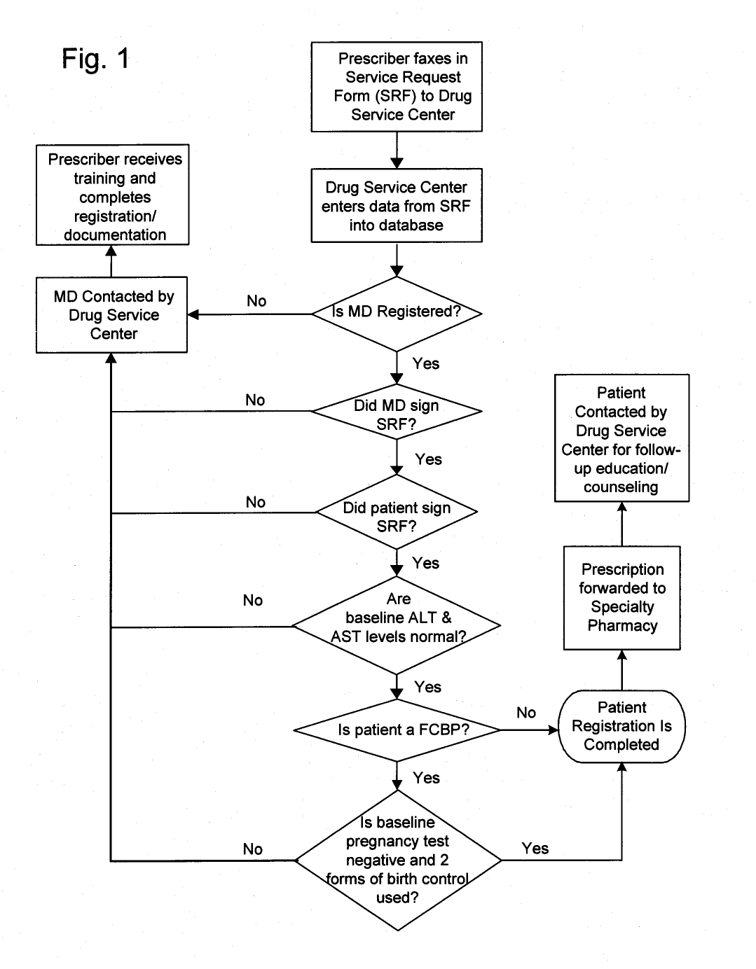

An exemplary process for registering a patient with the drug service center is demonstrated in the flow chart in FIG. 1. As shown in the figure, once the service request form is complete, the prescriber submits the service request form to the drug service center, where the drug service center completes the patient registration. The drug service center enters the patient-specific data into the database, and preferably assigns a unique identification number to the patient. Then, the drug service center verifies that the prescriber is registered, and that the registered prescriber, and the patient have signed the service request form. If the response to any of these inquiries is negative, then the drug service center preferably contacts the prescriber to alert them that they are unable to register the patient. The prescriber may receive additional training and then takes additional steps to successfully complete the patient registration. The drug service center may contact the patient to verify the information included on the service request form and ensure that they have been provided with a package insert and patient medication guide. If necessary, the drug service center may provide additional education or training, as appropriate, or provide additional counseling, for example, on the risks and benefits of taking the drug. Once the information is verified, a patient profile is preferably created in the database, which will contain patient information collected throughout the treatment program, and will be used to track the patient throughout the program.

As shown in FIG. 1, before the patient registration is complete (and before a prescription or prescription approval will be released to a specialty pharmacy), diagnostic test results are provided to the drug service center to document baseline liver function, and verify that the patient is not pregnant. This testing may be done with the prescriber or with another laboratory either before or after the service request form is submitted to the drug service center. Required testing includes hepatitis testing to confirm that the patient's alanine aminotransferase (ALT) and aspartate aminotransferase (AST) levels are less than three times the upper limit of normal (ULN).

In addition, a female patient is screened to determine if she is a female of child bearing potential (FCBP). At registration, prescribers are provided a tool to assist with screening for FCBP. A female patient is not considered a female with child bearing potential (FCBP) if any of the following criteria are met: (1) the patient is surgically sterile, (ii) the patient is post-menopausal (i.e., no menstrual period for longer than 12 consecutive months confirmed by a doctor), (3) the patient is incapable of pregnancy (as confirmed by a doctor); and (4) the patient is practicing abstinence (no sexual contact with a male).

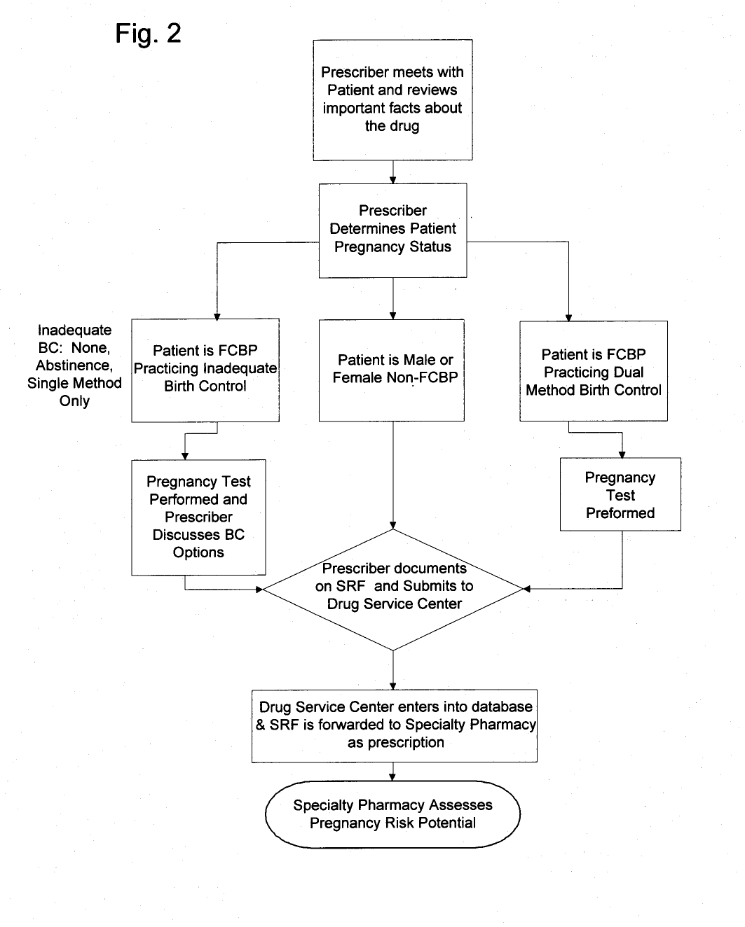

Any female patient that is identified as a FCBP, must be screened to confirm that she is not pregnant. An exemplary method for confirming that a patient is not pregnant is demonstrated by the flow chart in FIG. 2. As shown in the figure, a prescriber may make this determination before releasing the service request form to the drug service center. The prescriber may approach this determination from a few different angles depending on the status of the patient. For example, if the prescriber confirms that patient is male or a post-menopausal female or a surgically sterile female patient, no additional testing may be required. Alternatively, if the patient is a FCBP, then he may determine whether she is practicing adequate birth control, i.e., dual-method birth control. If so, then the prescriber may require that a pregnancy test be performed to confirm that the patient is not pregnant. If, however, the patient is using inadequate birth control, i.e., using one or no method of birth control, then the prescriber may counsel the patient regarding their birth control options, in addition to requiring a pregnancy test to confirm that the patient is not pregnant. The status of the patient, and the type of birth control that the patient is using are documented, and the results of the pregnancy tests are entered into the service request form, which the data service center enters into the patient profile in the database. Confirmation of these test results is necessary before a the patient can be completely registered, and a prescription released to a specialty pharmacy.

Once the patient's baseline lab test results have been confirmed, the prescription is sent to a specialty pharmacy, instructing the specialty pharmacy to dispense sitaxsentan sodium to the patient. The drug service center will select a limited network of specialty pharmacies to dispense sitaxsentan sodium. These specialty pharmacies will be chosen based on demonstrate prior experience with specialty products, preferably PAH specialty therapies. For a particular patient, the specialty pharmacy may be selected based on the patient's preference and factors such as in-network insurance relationships. Each specialty pharmacy will be trained prior to their registration, and on a regular basis thereafter, such as through the drug package insert, a patient medication guide, and protocols for reporting all adverse events, known drug-drug interactions, and the need for adjustment of warfarin dosing upon initiation of the drug therapy. The specialty pharmacies agree not to dispense sitaxsentan sodium unless the patient has been successfully registered through the drug service center. If a patient or prescriber attempts to contact the specialty pharmacy directly with a new prescription, the specialty pharmacy must direct them to the drug service center for appropriate registration. The specialty pharmacy is educated and trained on the risks and benefits of sitaxsentan sodium, and is in a position to screen the patient for risks associated with concomitant medications.

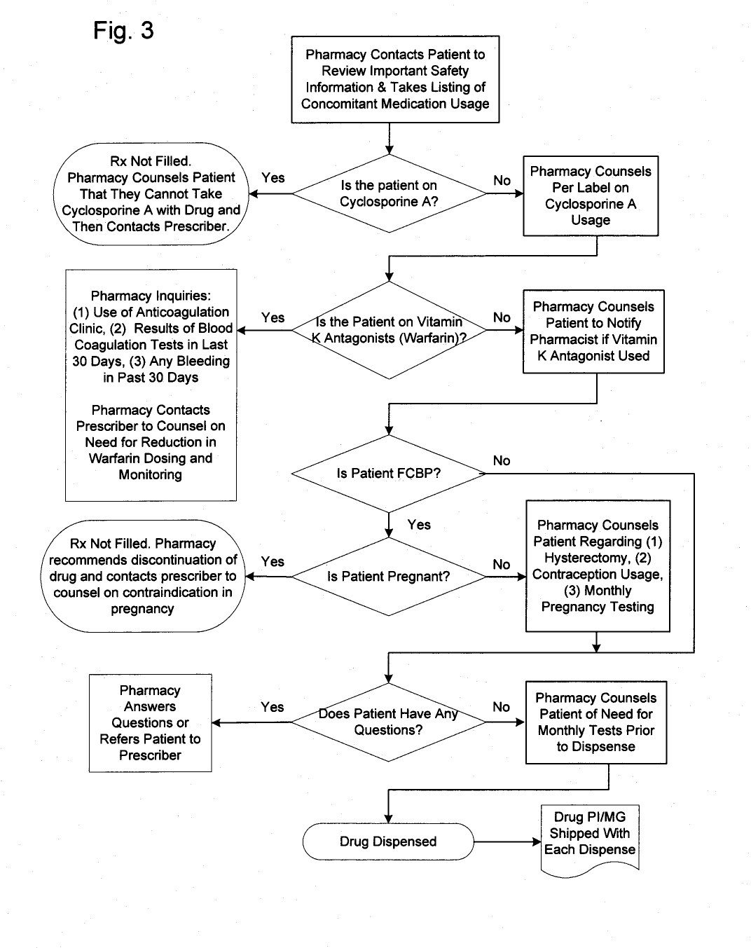

As shown in FIG. 3, the specialty pharmacy will also provide counseling from a licensed pharmacist to the patient prior to dispensing the sitaxsentan sodium. This counseling will include, but not be limited to, reviewing drug prescribing information with the patient (including a review of dose, dosage frequency, route of administration, possible side effects, risks/benefits, and known drug-drug interactions). In addition, the pharmacy is will determine if the patient has any contraindicated conditions or taking any contra indicated medications. For example, the pharmacy will determine if the patient is taking cyclosporine A, and if so, will counsel that the patient not take the drug, and will contact the prescriber to initiate further counseling. The pharmacy will also determine whether the patient is using vitamin K antagonists (e.g., warfarin, or COUMADIN). If the patient is using a vitamin K antagonist, the pharmacist will follow up to with additional education and counseling, such as to determine if the patient is followed by an anticoagulation clinic, and whether the patient has had his or her blood coagulation tested in the past 30 days, or if the patient has had any bleeding within the past 30 days. The pharmacy will document this information, and will contact the prescriber to counsel on the need for reduction in vitamin K antagonists, and monitoring. The pharmacist will also determine if the patient is a FCBP, and if so, whether the patient is pregnant. If the patient is pregnant, the prescription will not be filled, and the pharmacy will recommend discontinuation of the drug, and will contact the prescriber immediately to counsel on contraindication of pregnancy. If the patient is not pregnant, the pharmacy will counsel the patient regarding the use of two forms of contraception, and the need to have monthly pregnancy tests performed.

The pharmacy also will allow for open-ended questions regarding the drug or the program, and will answer any questions or refer the patient to the prescriber for additional counseling, if necessary. In addition, the pharmacy will counsel the patient on the necessity of having monthly blood tests prior to dispensing the drug. The pharmacy will verbally verify that the patient understands the provided information prior to dispensing the product and will document this electronically in the patient's file. The pharmacy is required to send all of the above information to the drug service center as a part of the electronic record sent daily.

Once all of the patient's information has been verified, the specialty pharmacy may dispense the prescribed drug to the patient. The pharmacy will dispense only a limited quantity of the drug to the patient (e.g., no more than 30 days worth). The pharmacy may dispense the drug either directly to the patient, or to the prescriber. The prescriber will be contacted by the specialty pharmacy notifying them of the drug dispense date to the patient and will reiterate the requirement to monitor for liver abnormalities and pregnancy (if applicable).

After the initial prescription has been filled and the patient starts therapy, the patient enters the initial treatment phase of the method. Generally, during this period patients are adjusting their routine to accommodate the new medication and lab testing routine and may have additional questions. During the initial treatment phase, patients follow a schedule of monthly monitoring, including the laboratory tests conducted in the baseline testing. Once the patient profile has been updated with the results of the monthly monitoring tests, the results are available to drug safety analyst, and the prescriber for review.

During this phase of the program, the web portal provides an important tool to improve communication of risk, safety and precautionary information, and is key to intervention in risk minimization. This communication and record keeping is a critical link between the prescriber, the patient, the pharmacy and the drug safety department. The web portal provides access to the patient profile. The web portal will allow prescribers to see prescription status, the date of the last patient reported lab test, determination of the patients' designated specialty pharmacy, and links to reach the specialty pharmacy. This coordination of data for the prescriber allows the prescriber to easily follow the path of their patient through the program, and minimizes the administrative burden of managing multiple patients with multiple needs. The web portal also links the prescriber to the drug safety department by providing a telephone number to reach the drug safety department regarding questions or issues. In addition, the web portal enables the drug manufacturer or distributor to identify, and contact every past and current prescriber of the drug in an appropriate manner.

During the initial treatment phase, qualified health professionals employed by the drug service center will make outbound calls to registered patients approximately two weeks after starting the drug treatment. The purpose of this call is to review important safety information for the drug, confirm continuing laboratory test scheduling by the patient, and conduct an assessment to resolve identified barriers to patients fulfilling laboratory testing requirements. In the event that a barrier to patients fulfilling laboratory testing requirements is identified, the drug service center will work with the prescriber and the patient to assist in ensuring testing is scheduled.

During the initial treatment phase of the program, a drug safety department may review the patient profile to determine the occurrence of risk factors. The patient profile, including the monthly monitoring test results, is made available for access by a drug safety center and the registered prescriber, for review. The drug safety center employs one or more trained drug safety analysts to review the monthly monitoring test results on a regular basis. If the drug safety analyst notices that the patient's blood tests indicate that the patient has an ALT or AST of greater than three times the ULN, the analyst will contact the prescriber, and will initiate appropriate further laboratory monitoring by the prescriber. Similarly, if the drug safety analyst notices that there has been a positive pregnancy test the staff member will contact the prescriber to assure the he or she is aware of this result, and can take appropriate action, such as adjusting the drug therapy, recommending additional testing, or discontinuing the drug therapy. Following any abnormalities, once the patient again exhibits normal lab test results and is not pregnant, the specialty pharmacy may continue to dispense the drug to the patient, and the monthly monitoring and lab alert systems continue.

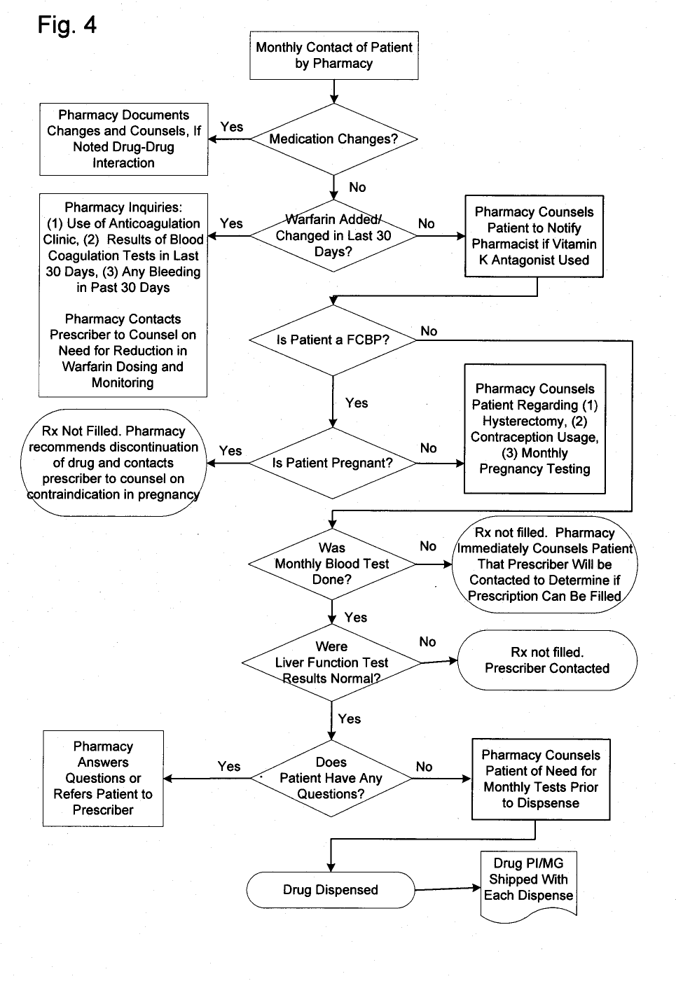

Since the drug is dispensed as part of a maximum 30-day refill cycle, the specialty pharmacy will contact the patient at least every 21-28 days to assure sufficient time to assure that the monthly lab tests are obtained before the patient runs out of their medication. As shown in FIG. 4, during this contact, the pharmacy will inquire if there have been any changes in the patient's medications, and will document such changes, and note any potential drug-drug interactions. The pharmacy also will ask if any vitamin K antagonists have been added or doses changed since the last prescription refill. If so, the pharmacy will ask additional follow-up questions, and, if necessary, will contact the prescriber to counsel for the need to reduce the dosing. The pharmacist will also determine if the patient is a FCBP, and if so, whether the patient is pregnant. If the patient is pregnant, the prescription will not be filled, and the pharmacy will recommend discontinuation of the drug, and will contact the prescriber immediately to counsel on contraindication of pregnancy. If the patient is not pregnant, the pharmacy will counsel the patient regarding the use of two forms of contraception, and the need to have monthly pregnancy tests performed. The pharmacy also will allow for open-ended questions regarding the drug or the program, and will answer any questions or refer the patient to the prescriber for additional counseling, if necessary.

The pharmacy also must inquire as to whether the monthly liver function tests were performed, and whether the results were normal. If the tests were not performed, the prescription will not be filled until the patient has had the tests, and the results are normal. If the laboratory test results indicate that the patient's blood levels are abnormal, the specialty pharmacy will be unable to dispense the prescription to the patient, and the prescriber will be notified so that he or she is aware of the results, and can take appropriate action.

The program prescribes several actions that may be taken by the pharmacy, should any abnormal event occur. In the event that the pharmacy is unable to reach the patient to conduct this monthly contact, the pharmacy will contact the prescriber to notify them of the situation. The drug will not be dispensed until the pharmacy is able to perform the monthly contact with the patient. In the event that the pharmacy is unable to reach the provider, the patient will be informed that their physician can not be reached, and the prescription will be held until the pharmacist is able to reach the prescriber. In the event that the patient states that the lab results were not conducted, the pharmacy advises the patient verbally that the drug will not be dispensed until their prescribing physician provides authorization. The pharmacy then contacts the prescriber to notify them of the patient's statement and determines from the prescriber the course of action. In the event that the patient states that the lab tests were conducted, but is unaware of the results, the specialty pharmacy specifically asks the patient for the date of the lab monitoring.

In the event that the lab monitoring tests are abnormal, the pharmacy is to consult with the prescriber to determine from the prescriber the course of action. The pharmacy is to provide counseling to the prescriber of labeled recommendations including ongoing monitoring and stopping rules. The pharmacy notifies the drug safety department of the abnormal test results. If required by state or federal laws and regulations, the pharmacy will report any qualifying adverse event to the appropriate authorities.

Once the specialty pharmacy confirms with the patient that the laboratory testing results are acceptable, and that there are no other contra-indicated conditions, the pharmacy may dispense the drug to the patient. Following any test abnormalities, the specialty pharmacy will not be able to dispense the drug to the patient until they can offer proof that the patient has normal lab testing results, and that the patient is not pregnant. The pharmacy will document the above information to the drug service center as a part of the electronic record sent daily.

The final phase of the program is a maintenance phase. Generally, this phase occurs after approximately four to six weeks of initial therapy, after the drug therapy program has stabilized. During this phase, the patient continues the monthly monitoring tests. The pharmacy or a member of the drug service center may remind the patient to continue their monthly lab tests. The drug safety analyst and the prescriber continue to monitor the results in the patient profile, and adjust the therapy as necessary. The specialty pharmacies will continue to perform the monthly contact of the patient, following the same procedures described above, and will only be allowed to dispense the prescription to the patient if the laboratory test results were not abnormal, the patient is not pregnant, and there are no other contra-indicated conditions. In addition, if the patient does not request a refill, the specialty pharmacy will determine the reason and will report this to the data service center.

When the method is performed as described herein, no patient will receive sitaxsentan sodium unless the following criteria have been met: (1) the patient has been registered at the drug service center and have been given a patient identification number; (2) the prescriber has been registered at the drug service center; (3) a service request form has been filed with the drug service center that has been signed and dated by the patient, indicating consent to receive monthly lab monitoring, and acknowledging that they have received education on the risks and benefits of using sitaxsentan sodium; (4) they have been screened by their prescriber to determine if they are a female of child-bearing potential, and have been counseled by their prescriber to avoid pregnancy and to use two forms of effective birth control at all times; (5) the prescriber has signed and dated the enrollment form attesting that the prescriber has discussed the risks and benefits of taking sitaxsentan sodium, and agrees to monitor the patient on a monthly basis; (6) there is documentation of the patient's baseline liver function testing; (7) there is documentation that, if the patient is a female and of childbearing potential, the patient is not pregnant; (8) the patient has received a medication guide prior to taking sitaxsentan sodium; (9) the patient has been offered counseling by a qualified pharmacist through a specialty pharmacy; and (10) the patient has been provided education on the need for warfarin dose adjustment (if applicable) when they start taking sitaxsentan sodium.

When the method is performed, no prescriber will prescribe sitaxsentan sodium unless the following criteria have been met: (1) the prescriber is registered at the drug service center; (2) the prescriber has counseled the patient regarding the need for monitoring for liver abnormalities; (3) the prescriber has screened female patients for child-bearing potential, and has counseled females of childbearing potential to avoid pregnancy and to use two forms of birth control to avoid pregnancy, and this has been documented on the drug service center enrollment form; (4) the prescriber has been provided guidelines on warfarin adjustment, if applicable, for the patient based on the drug labeling recommendations; and (5) the prescriber has agreed to monitor for liver abnormalities and, if applicable, pregnancy in the patient while the patient is exposed to the drug and has signed the attestation statement on the service request form.

When the method is performed, no pharmacy will dispense sitaxsentan sodium unless the following criteria have been met: (1) the pharmacy is a registered specialty pharmacy; (2) the pharmacy agrees not to dispense sitaxsentan sodium unless the patient has been registered first through the drug service center; (3) the pharmacy has been trained prior to the first dispense of the drug and regularly thereafter; (4) the pharmacy has screened females for childbearing potential upon receipt of a new prescription and have evidence of this in their documentation; (5) the pharmacy has included with every bottle of the drug, the package insert and patient medication guide; (6) the pharmacy has questioned the patient regarding the concomitant medication usage and if the patient is taking warfarin, and has provide counseling regarding the need for dosage adjustment and follow-up; (7) prior to each dispense of the drug, the pharmacy has verified with the patient that the patient has had their monthly lab monitoring and, if the patient is a female of childbearing potential, that the patient is not pregnant; (8) the pharmacy has counseled female patients of childbearing potential to notify the prescriber and specialty pharmacy provider immediately if she suspects she might be patient; (9) the pharmacy can provide a complete listing of each patient dispensed the drug including current address and phone number.

While the invention has been described with reference to particularly preferred embodiments and examples, those skilled in the art recognize that various modifications may be made to the invention without departing from the spirit and scope thereof.

What is claimed is:

1. A method for restricted distribution of a drug to a patient while minimizing the occurrence of adverse side effects, by preventing access to the drug to certain patients for whom the drug may be contraindicated, said method comprising:
providing a database;
registering at least one prescriber in the database;
registering at least one pharmacy in the database;
registering the patient in the database;
creating a patient profile in the database, and associating the patient profile with the patient, the at least one registered prescriber, and the at least one registered pharmacy;
creating a prescription request, initiated by the prescriber, wherein the prescription request is an order for the drug to be dispensed to the patient, wherein the prescription request is associated with the patient profile in the database;
enabling the at least one registered prescriber to access the patient profile in the database;
defining a set of health-related information, wherein said set of health-related information is probative of the risk that an adverse side effect is likely to occur if a patient is exposed to the drug;
defining a set of screening criteria for the health-related information, wherein when the health-related information does not satisfy the screening criteria, the risk that an adverse side effect is likely to occur is unacceptable;
obtaining a baseline set of patient-specific health-related information from the patient, and associating the baseline set of patient-specific health-related information with the patient profile;
based at least in part on the baseline set of patient-specific health-related information in the patient profile and the pre-defined screening criteria, determining whether the risk is unacceptable that the patient will experience an adverse side effect upon exposure to the drug;
upon a determination that the risk is not unacceptable, permitting the at least one registered pharmacy to dispense the drug to the patient as ordered by the prescription request;
upon a determination that the risk is unacceptable, prohibiting the at least one registered pharmacy from dispensing the drug to the patient as ordered by the prescription request.

2. The method of claim 1, wherein registering a patient, a prescriber, or a pharmacy in the database comprises:
providing counseling and education to the patient, prescriber, or pharmacy, respectively, regarding the risks and benefits of the drug, the known side effects of the drug, the method for restricted distribution of the drug, or a combination thereof;
submitting a registration form that contains information specific to the patient, prescriber or pharmacy, respectively;
recording the information on the registration form in the database; and
confirming that the patient, prescriber, or pharmacy, respectively, understands the method for restricted distribution of the drug, and intends to comply with the method.

3. The method of claim 2, wherein registering the patient additionally comprises:
submitting patient-specific health-related information;
determining that the patient does not exhibit any health-related conditions that are contraindicated for the drug; and
submitting an informed-consent form executed by the patient, whereby the patient commits to adhering to the method for restricted distribution of the drug.

4. The method of claim 1, additionally comprising educating other organizations or individuals who will likely interact with the patient, at least with respect to the risks and benefits of the drug, the known side effects of the drug, the method for restricted distribution of the drug, or a combination thereof,
wherein the other organizations or individuals who will likely interact with the patient comprise: laboratories, hospitals, clinics, and combinations thereof.

5. The method of claim 1, wherein only registered prescribers, registered patients, and registered pharmacies have access to the drug.

6. The method of claim 1, wherein the prescriber makes the determination that the risk is unacceptable.

7. The method of claim 1, wherein the pharmacy has access to the patient's profile in the database, and the pharmacy makes the determination as to whether the risk is unacceptable.

8. The method of claim 1, wherein the set of health-related information comprises at least one predetermined diagnostic laboratory test.

9. The method of claim 8, wherein the at least one diagnostic laboratory test comprises a test probative of the patient's liver function, a test probative of the patient's pregnancy status, or a combination thereof.

10. The method of claim 1, wherein the set of health-related information comprises a determination of concomitant medications that the patient is taking.

11. The method of claim 1, wherein the set of health-related information is obtained at least in part from the patient's participation in an verbal, written, or electronic survey, interview, or questionnaire.

12. The method of claim 1, wherein the set of health-related information is obtained, at least in part, from the registered pharmacy or the registered prescriber, based on the registered pharmacy's or registered prescriber's respective knowledge of the patient and the patient's condition.

13. The method of claim 1, additionally comprising:
providing a drug service center that is responsible for managing the method, and ensuring compliance of the registered patient, the at least one registered prescriber, and the at least one registered pharmacy.

14. The method of claim 13, wherein the drug service center is accessible to the registered patient, the at least one registered prescriber, and the at least one registered pharmacy by telephone, facsimile, internet, or a combination thereof.

15. The method of claim 13, wherein the drug service center maintains the database.

16. The method of claim 13, wherein the drug service center registers the at least one prescriber, the at least one pharmacy, the at least one patient, or a combination thereof.

17. The method of claim 13, wherein the drug service center contacts the registered patient before or after the drug has been dispensed to ensure that the patient is educated on the risks and benefits of the drug, the known side effects of the drug, and the method for restricted distribution of the drug, and that the patient is complying with the method.

18. The method of claim 14, wherein the drug service center additionally asks the patient if the patient has any questions or concerns, and in response the drug service center answers these questions or concerns, or refers the patient to the registered prescriber for counseling.

19. The method of claim 13, wherein the drug service center collects health-related information from the patient, and records it in the patient-profile in the database.

20. The method of claim 1, additionally comprising:
providing one or more drug safety analysts;
wherein the drug safety analysts have access to the patient's profile in the database, and are responsible for analyzing the information in the patient profile on a regular basis;
wherein the one or more drug safety analysts make the determination that the risk is unacceptable.

21. The method of claim 20, additionally comprising:
upon a determination by the one or more drug safety analysts that the risk is unacceptable, notifying the at least one registered prescriber, the at least one registered pharmacy, the registered patient, or any combination of the above that said determination has been made.

22. The method of claim 1, wherein the database is maintained on a secure web portal.

23. The method of claim 1, additionally comprising:
creating a refill prescription request, wherein the refill prescription request is an order for the drug to be dispensed to the patient, wherein the refill prescription request is associated with the patient profile in the database;
obtaining a second set of patient-specific health-related information from the patient after the prescription has been dispensed by the pharmacy, and associating the second set of patient-specific health-related information with the patient profile; and
based at least in part on the second set of patient-specific health-related information in the patient profile and the pre-defined screening criteria, determining whether the risk is unacceptable that the patient will experience an adverse side effect upon continued exposure to the drug;
upon a determination that the risk is not unacceptable, permitting the at least one registered pharmacy to dispense the drug to the patient as ordered by the refill prescription request;
upon a determination that the risk is unacceptable, prohibiting the at least one registered pharmacy from dispensing the drug to the patient as ordered by the refill prescription request.

24. The method of claim 23, wherein the patient is required to supply the second set of patient-specific health-related information within a predetermined amount of time after receiving the initial prescription.

25. The method of claim 23, wherein prior to making the determination, the pharmacy contacts the patient, and determines whether the patient has supplied the second set of patient-specific health-related information.

26. The method of claim 25, wherein during the pharmacy-patient contact, the pharmacy collects at least a portion the second set of patient-specific health-related information.

27. The method of claim 1, wherein the drug is sitaxsentan sodium.

28. A method for restricted distribution of a drug to a patient while minimizing the occurrence of adverse side effects, by preventing access to the drug to certain patients for whom the drug may be contraindicated, said method comprising:
providing a database;
registering one or more patients in the database;
associating each of the one or more registered patients with respective patient profiles in the database;
defining a baseline set of health-related information to be obtained from each of the one or more patients before the patient receives the drug, wherein said set of health-related information is probative of the risk that an adverse side effect is likely to occur if the patient is exposed to the drug;
obtaining a baseline set of patient-specific health-related information from each of the one or more patients, and associating each of the baseline sets of patient-specific health-related information with the respective patient profiles;
after obtaining baseline sets of patient-specific health-related information from each of the one or more patients, dispensing the drug to each of the one or more patients;
defining a second set of health-related information to be obtained from each of the one or more patients after the drug has been dispensed to the patient, wherein said second set of health-related information is probative of the risk that an adverse side effect is likely to occur if the patient continues to be exposed to the drug;
obtaining at least one second set of patient-specific health-related information from each of the one or more patients at a predetermined interval after the drug has been dispensed to the one or more patients, and associating each of the second sets of patient-specific health-related information with the respective patient profiles; and
evaluating the baseline and second sets of patient-specific health-related information in the collective patient profiles to determine the overall risk of side effects of the drug.
